(19) United States
(12) Patent Application Publication
(10) Pub. No.: US 2023/0196207 A1
(43) Pub. Date: Jun. 22, 2023

(54) METHOD AND SYSTEM FOR ADAPTIVELY STREAMING ARTIFICIAL INTELLIGENCE MODEL FILE

(71) Applicant: SAMSUNG ELECTRONICS CO., LTD., Suwon-si (KR)

(72) Inventors: Prasenjit CHAKRABORTY, Bengaluru (IN); Narasimha Rao THURLAPATI, Bengaluru (IN); Srinidhi N, Bengaluru (IN); Eric Ho Ching YIP, Suwon-si (IN); Jyotirmoy KARJEE, Bengaluru (IN); Jaskamal KAINTH, Bengaluru (IN); Ramesh Badu VENKAT DABBIRU, Bengaluru (IN)

(73) Assignee: SAMSUNG ELECTRONICS CO., LTD., Suwon-si (KR)

(21) Appl. No.: 18/109,042

(22) Filed: Feb. 13, 2023

Related U.S. Application Data
(63) Continuation of application No. PCT/KR2022/017670, filed on Nov. 10, 2022.

(30) Foreign Application Priority Data
Nov. 12, 2021 (IN) 202141051968
Oct. 21, 2022 (IN) 202141051968

(51) Int. Cl. G06N 20/00

(52) U.S. Cl. CPC G06N 20/00

(57) ABSTRACT

Provided is a method for adaptively streaming an artificial intelligence (AI) model file, including determining a capability of a first electronic device and a capability of a second electronic device, network information associated with the first and second electronic devices, and AI model information associated with the AI model file; determining to adaptively stream the AI model file based on the determined capabilities and information; pre-processing the AI model file; and adaptively streaming the AI model.

### CROSS-REFERENCE TO RELATED APPLICATION(S)

This application is a bypass continuation of PCT International Application No. PCT/KR2022/017670, filed on Nov. 10, 2022, which claims priority to Indian Provisional Patent Application No. 202141051968, filed on Nov. 12, 2021, and Indian Complete Patent Application No. 202141051968, filed on Oct. 21, 2022, in the Indian Intellectual Property Office, the disclosures of which are incorporated by reference herein in their entireties.

### BACKGROUND

### 1. Field

The disclosure relates to a method and a system for adaptively streaming an Artificial Intelligence model file.

### 2. Description of Related Art

Artificial Intelligence (AI)/Machine Learning (ML) based mobile device applications are computationally intensive, memory-intensive, and power-intensive. Mobile devices (e.g., smartphones) typically have rigid energy consumption, and computing requirements for running an offline AI/ML inference on board. Many AWL-based mobile device applications, such as image/video recognition, offload inference processing from the mobile devices to an Internet Data Center (IDC). For example, photos taken with the mobile devices are frequently processed in a cloud-based AI/ML model and/or a pre-loaded AI/ML model(s) before being displayed to a user. However, cloud-based AI/ML inference tasks must consider DC computation pressure and required data rate/latency.

Convolutional Neural Network (CNN) models have been used on the mobile devices for the image/video recognition tasks such as image classification, image segmentation, object localization, object detection, face authentication, action recognition, enhanced photography, Virtual Reality (VR)/Augmented Reality (AR), and video games. However, CNN model inference requires a significant amount of computation and storage space.

Pre-loading of all possible AI/ML model(s) (offloading AI/ML inference) is impractical due to limited storage on the mobile devices, and AI/ML model(s) downloading and/or transfer learning is required. However, downloading the AI/ML model(s) may require a higher data rate (likely greater than enhanced Mobile Broadband (eMBB) capability) than offloading AI/ML inference, but downloading the AI/ML model(s) can significantly reduce latency requirements. As illustrated in FIG. 1, to download the AI/ML model(s) at destination devices (e.g., mobile devices), the mobile devices must first wait for the entire AI/ML model(s) (whether the entire original model or a spitted original model) to download before starting inferencing using an input data, which is a major drawback in certain existing methods/systems. FIG. 1 illustrates a system in the related art for sending an AI model file (e.g., VGG16.tflite) from an application server 20 to a User Equipment (UE) 10. In the system, the UE 10 waits for the entire AI model file to download before starting inferencing using the input data 30. As a result, there is a delay in getting an output because the download and execution do not work in parallel. Furthermore, certain methods/systems in the related art prefer an optimal model to always execute. Instead of saving the AI/ML model(s) (wasting Read-Only Memory space), these methods/systems always download the optimal model from the application server 20 and execute the AI/ML model(s).

Furthermore, certain methods/systems in the related art do not allow the AI/ML model(s) to be inferred during process of the downloading. As a result, there is always an initial delay when attempting to infer a full/partial AI/ML model(s) remotely, especially when the AI/ML model(s) is/are larger in size (e.g., Terabytes).

Thus, it is desired to address the above-mentioned disadvantages or other shortcomings or at least provide a useful alternative for adaptively streaming the AI/ML model(s).

### SUMMARY

Provided is a method for adaptively streaming of an Artificial intelligence (AI) model file from a first electronic device (e.g., server) to a second electronic device (e.g., smartphone) based on a time required to send a complete AI model or a partial AI model(s) of the AI model file (adaptively streaming). The adaptively streaming may be determined based on a capability of the first electronic device, a capability of the second electronic device, network information, and AI model information. As a result, in the case of partial AI model(s), the second electronic device does not wait for the complete AI model to be downloaded before beginning Inferencing using input data. Hence, there is no initial delay when the second electronic device attempts to infer the complete AI model or partial AI model(s), especially when the AI model file(s) is larger in size (e.g., Terabytes).

The adaptively streaming may be performed based on pre-processing. The pre-processing may include analyzing an AI architecture of the complete AI model, splitting the complete AI model into one or more partial AI models, creating a model description file to send to the second electronic device, and encoding/encrypting/pruning the one or more partial AI models (e.g., Digital Rights Management (DRM)). The model description file includes location information of one or more partial AI models, where the location information includes tag information (e.g., a recommended tag a mandatory tag, etc.) associated with each layer of the complete AI model or the partial AI model(s).

One or more partial AI models may be sent to the second electronic device by (a) sending the entire AI model file(s), whether pushed by the first electronic device (e.g., server) or requested by the second electronic device (e.g., client device); and (b) splitting AI models layers into two types, namely recommended tags/layers and mandated tags/layers. The first electronic device may decide to push only mandated layers to the second electronic device based on its understanding of upload bandwidth or network congestion; and (c) based on download bandwidth or network congestion, the first electronic device can decide to create the model description file, which will list down all sub-model layers and associated mandatory/recommended tags and push the model description file at the start. The model description file can later be used by the second electronic device to determine which layers to request.

One or more actions (e.g., download, parallel download, execute, parallel execute, etc.) may be performed at the second electronic based on the received model description from the first electronic device associated with the one or more partial AI models and/or received the complete AI model from the first electronic device.

According to an aspect of the disclosure, a method for adaptively streaming an artificial intelligence (AI) model file from a first electronic device to a second electronic device, includes: determining, by the first electronic device, a capability of the first electronic device and a capability of the second electronic device; determining, by the first electronic device, network information associated with the first electronic device and the second electronic device; determining, by the first electronic device, AI model information associated with the AI model file; based on the capability of the first electronic device, the capability of the second electronic device, the network information, and the AI model information, determining, by the first electronic device, whether to adaptively stream the AI model file from the first electronic device to the second electronic device; pre-processing the AI model file, by the first electronic device, based on the determining to adaptively stream the AI model file from the first electronic device to the second electronic device; and adaptively streaming the AI model file, by the first electronic device, from the first electronic device to the second electronic device based on the pre-processing.

The capability of the first electronic device and the capability of the second electronic device may be determined based on at least one of a processor, a memory, a battery status, and a device health condition of the first electronic device or the second electronic device.

The capability of the first electronic device or of the second electronic device may indicate at least one of a processing time for at least one partial AI model, an execution time for the at least one partial AI model, an inference time for the at least one partial AI model, a split time for the at least one partial AI model, and a transfer time for the at least one partial AI model.

The network information may include a type of network, a bandwidth information, a latency information, a handover information, a mobility information, a download link information, an uplink information, a data transmission speed, a type of data transfer between the first electronic device and the second electronic device, and a size of the data transfer between the first electronic device and the second electronic device.

The AI model information may include a type of AI-architecture, a type of data used in the type of AI-architecture, a type of link used in the AI-architecture, and a cross-layer dependency in the AI-architecture.

The pre-processing may indicate at least one of a split of a complete AI model into at least one partial AI model at the first electronic device, a parallel download of the at least one partial AI model at the second electronic device, a parallel inference at the second electronic device, and encoding the at least one partial AI model.

The pre-processing may include: analyzing, by the first electronic device, an AI architecture of the complete AI model of the AI model file; splitting, by the first electronic device, the complete AI model into the at least one partial AI model based on the capability of the first electronic device, the capability of the second electronic device, the network information, and the AI model information; and creating, by the first electronic device, a model description file to send to the second electronic device, wherein the model description file includes a location information of the at least one partial AI model, wherein the location information includes at least one of a recommended tag and a mandatory tag.

The splitting, by the first electronic device, the complete AI model into the at least one partial AI model may include: converting, by the first electronic device, a sequential model of the complete AI model into a functional model, wherein the functional model includes at least one of multiple inputs, multiple outputs, shared layers, and nested models; creating, by the first electronic device, model metadata for each layer of the complete AI model, wherein the model metadata includes at least one of input layer information, output layer information, layer names, model names, inbound nodes information, and outbound nodes information; determining, by the first electronic device, an input shape for each layer; storing, by the first electronic device, the model metadata and the input shape for each layer into a memory; and creating, by the first electronic device, at least one sub-AI model for each layer based on the model metadata.

The creating, by the first electronic device, the at least one sub-AI model for each layer based on the model metadata may include: storing, by the first electronic device, outer configuration of the at least one sub-AI model configuration for each layer; adding, by the first electronic device, input layer configuration in the at least one sub-AI model configuration based on a layer requirement for each layer, wherein an input layer is treated as a previous layer for a current layer and the current layer is treated as an output layer for the at least one partial-AI model configuration for each layer; extracting, by the first electronic device, weights of a current layer of the complete AI model; applying, by the first electronic device, a compression mechanism on the extracted weights; storing, by the first electronic device, the extracted weights in the at least one sub-AI model; and creating, by the first electronic device, the one sub-AI model for each layer using the extracted weights.

The method may further include: receiving, by the second electronic device, the AI model file from the first electronic device to the second electronic device, wherein the AI model file includes at least one partial AI model from the first electronic device, and the second electronic device downloads the at least one partial AI model to execute the AI model file.

The receiving, by the second electronic device, the at least one partial AI model from the first electronic device further may include: determining, by the second electronic device, whether a model description file includes a recommended tag or a mandatory tag; parallel downloading, by the second electronic device, the at least one partial AI model based on the recommended tag and the mandatory tag, and the capability of the second electronic device, the network information, and the AI model information; and parallel executing, by the second electronic device, the at least one partial AI model.

The parallel executing, by the second electronic device, the at least one partial AI model may include: executing, by the second electronic device, a first AI sub-model of the at least one partial AI model based on already available input data; detecting, by the second electronic device, that an inference is completed for the first AI sub-model; and executing, by the second electronic device, a second AI sub-model of the at least one partial AI model by using an output of the first AI model as an input for the second AI model upon detecting that the inference is completed for the first AI model.

The detecting, by the second electronic device, that the inference is completed for the first AI model may include: loading, by the second electronic device, model metadata for each layer of the complete AI model, wherein the model metadata includes at least one of input layer information, output layer information, layer names, model names, inbound nodes information, and outbound nodes information; storing, by the second electronic device, an output of each layer along with a count, wherein the count indicates a number of times the output is used; and detecting, by the second electronic device, that the inference is completed for the first AI model based on the count.

The capability of the first electronic device and the capability of the second electronic device may be determined based on an initial handshake between the first electronic device and the second electronic device.

According to an aspect of the disclosure, a first electronic device for adaptively streaming an artificial intelligence (AI) model file, includes: a memory storing instructions; and at least one processor configured to execute the instructions to: determine a capability of the first electronic device and a capability of a second electronic device; determine network information associated with the first electronic device and the second electronic device; determine AI model information associated with the AI model file; based on the capability of the first electronic device, the capability of the second electronic device, the network information, and the AI model information, determine whether to adaptively stream the AI model file from the first electronic device to the second electronic device; pre-process the AI model file based on the determining to adaptively stream the AI model file from the first electronic device to the second electronic device; and adaptively stream the AI model file from the first electronic device to the second electronic device based on the pre-processing.

The pre-processing may indicate at least one of a split of a complete AI model into at least one partial AI model at the first electronic device, a parallel download of the at least one partial AI model at the second electronic device, a parallel inference at the second electronic device, and encoding the at least one partial AI model.

The at least one processor may be further configured to execute the instructions to: analyze an AI architecture of the complete AI model of the AI model file; split the complete AI model into the at least one partial AI model based on the capability of the first electronic device, the capability of the second electronic device, the network information, and the AI model information; and create a model description file to send to the second electronic device, wherein the model description file includes a location information of the at least one partial AI model, wherein the location information includes at least one of a recommended tag and a mandatory tag.

The at least one processor may be further configured to execute the instructions to: convert a sequential model of the complete AI model into a functional model, wherein the functional model includes at least one of multiple inputs, multiple outputs, shared layers, and nested models; create model metadata for each layer of the complete AI model, wherein the model metadata includes at least one of input layer information, output layer information, layer names, model names, inbound nodes information, and outbound nodes information; determine an input shape for each layer; store the model metadata and the input shape for each layer into the memory; and create at least one sub-AI model for each layer based on the model metadata.

The at least one processor may be further configured to execute the instructions to: store outer configuration of the at least one sub-AI model configuration for each layer; add input layer configuration in the at least one sub-AI model configuration based on a layer requirement for each layer, wherein an input layer treats as a previous layer for a current layer and the current layer treats as an output layer for the at least one partial-AI model configuration for each layer; extract weights of a current layer of the complete AI model; apply a compression mechanism on the extracted weights; store the extracted weights in the at least one sub-AI model; and create the one sub-AI model for each layer using the extracted weights.

The at least one processor is further configured to execute the instructions to: receive the AI model file from the first electronic device to the second electronic device, wherein the AI model file includes at least one partial AI model from the first electronic device, and the second electronic device downloads the at least one partial AI model to execute the AI model file.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a related art system for sending an Artificial Intelligence (AI) model file from an application server to a User Equipment (UE);

FIG. 2A illustrates a block diagram of a first electronic device for adaptively streaming an AI model file, according to an embodiment;

FIG. 2B illustrates a block diagram of a second electronic device for the adaptively receiving an AI model file, according to an embodiment;

FIGS. 3A and 3B are a flow diagram illustrating a method for the adaptively streaming an AI model file, according to an embodiment;

FIG. 4 is a sequence flow diagram illustrating an initial handshake between the first electronic device and the second electronic device, according to an embodiment;

FIG. 5 illustrates a system block diagram and various functionality for adaptively streaming an AI model file, according to an embodiment;

FIG. 6 is a flow diagram illustrating a splitting mechanism for the adaptively streaming an AI model file, according to an embodiment; and

FIGS. 7A, 7B, and 7C are sequence flow diagrams illustrating an inferencing mechanism for adaptively streaming an AI model file, according to an embodiment.

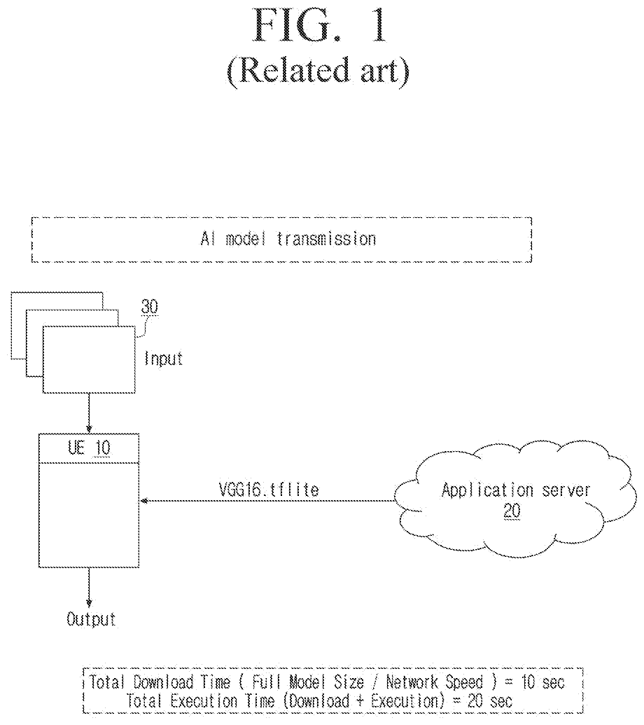

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

The following embodiments are explained in terms of the first and second electronic devices, but the disclosure is also applicable to multiple electronic devices.

Unlike existing related art methods and systems, the method according to an embodiment may adaptively stream the AI model file from the first electronic device (e.g., server) to the second electronic device (e.g., smartphone) based on the time required to send the complete AI model or the partial AI model(s) of the AI model file. The time required to send the complete AI model or the partial AI model(s) is determined based on the capability of the first electronic device and the second electronic device, the network information, and the AI model information. As a result, in the case of partial AI model(s), the second electronic device does not wait for the complete AI model to be downloaded before beginning Inferencing using input data. Hence, there is no initial delay when the second electronic device attempts to infer the complete AI model or partial AI model(s), especially when the AI model file(s) is larger in size (e.g., Terabytes).

Unlike existing related art methods and systems, the method according to an embodiment may determine the time required to send one or more partial AI models to the second electronic device based on pre-processing. The pre-processing includes analyzing an AI architecture of the complete AI model, splitting the complete AI model into one or more partial AI models, creating a model description file to send to the second electronic device, and encoding/encrypting/pruning the one or more partial AI models (e.g., Digital Rights Management (DRM)). The model description file includes location information of one or more partial AI models and, where the location information includes tag information (e.g., a recommended tag a mandatory tag, etc.) associated with each layer of the complete AI model or the partial AI model(s).

Unlike existing related methods and systems, the method according to an embodiment may perform one or more actions (e.g., download, parallel download, execute, parallel execute, etc.) at the second electronic based on the received model description from the first electronic device associated with the one or more partial AI models and/or received the complete AI model from the first electronic device.

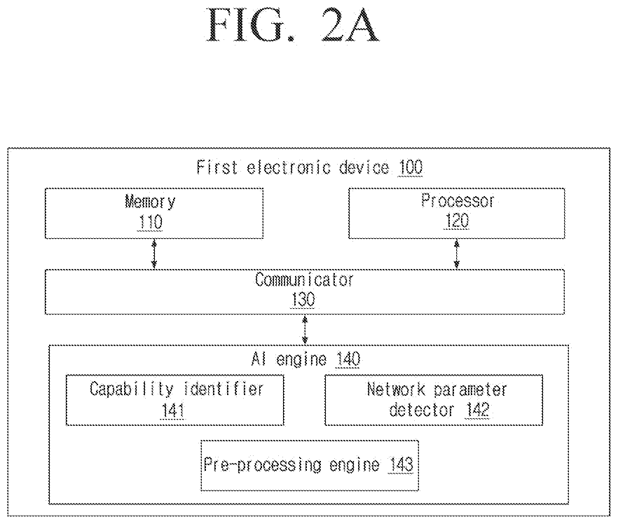

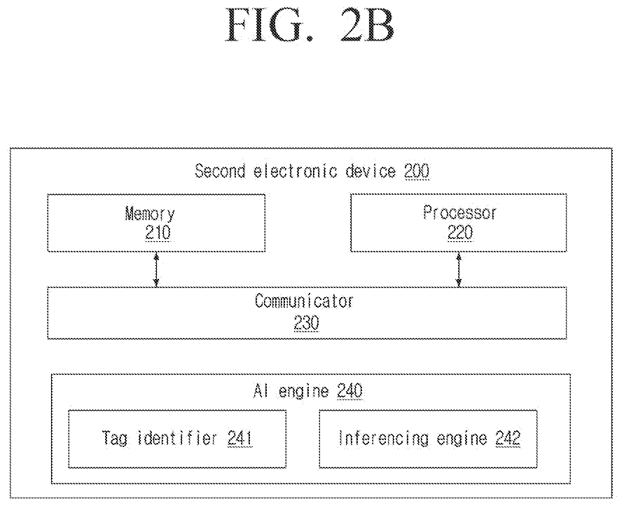

Referring now to the drawings and more particularly to FIGS. 2A-2B, 3, 4, 5, 6, 7A, 7B, and 7C, where similar reference characters denote corresponding features consistently throughout the figures, there are shown example embodiments.

FIG. 2A illustrates a block diagram of a first electronic device 100 for adaptively streaming an AI model file, according to an embodiment. Examples of the first electronic device 100 include, but are not limited to a server, a cloud server, a tablet computer, a smartphone, a Personal Digital Assistance (PDA), an Internet of Things (IoT) device, etc.

In an embodiment, the first electronic device 100 includes a memory 110, a processor 120, a communicator 130, and an AI engine 140.

In an embodiment, the memory 110 stores information associated with a capability of the first electronic device 100, a capability of a second electronic device 200, network information associated with the first electronic device 100 and the second electronic device 200, AI model information associated with the AI model file, a time required to send a complete AI model of the AI model file, a time required to send one or more partial AI models of the AI model file, a model description file, model metadata, configuration information (e.g., outer configuration), and weights information.

The memory 110 stores instructions to be executed by the processor 120. The memory 110 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 110 may, in some examples, be considered a non-transitory storage medium. The term “non-transitory” may indicate that the storage medium is not embodied in a carrier wave or a propagated signal. However, the term “non-transitory” should not be interpreted that the memory 110 is non-movable. In some examples, the memory 110 can be configured to store larger amounts of information than the memory. In certain examples, a non-transitory storage medium may store data that can, over time, change (e.g., in Random Access Memory (RAM) or cache). The memory 110 can be an internal storage unit or it can be an external storage unit of the first electronic device 100, a cloud storage, or any other type of external storage.

The processor 120 communicates with the memory 110, the communicator 130, and the AI engine 140. The processor 120 is configured to execute instructions stored in the memory 110 and to perform various processes. The processor 120 may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator 130 is configured for communicating internally between internal hardware components and with external devices (e.g., eNodeB, gNodeB, server, smartphone, IoT device, etc.) via one or more networks (e.g., Radio technology). The communicator 130 includes an electronic circuit specific to a standard that enables wired or wireless communication.

The AI engine 140 may be implemented the processor 120 or by other processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In an embodiment, the AI engine 140 includes a capability identifier 141, a network parameter detector 142, and a pre-processing engine 143.

In an embodiment, the capability identifier 141 determines the capability of the first electronic device 100 and the second electronic device 200 based on an initial handshake between the first electronic device 100 and the second electronic device 200. The capability of the first electronic device 100 and the second electronic device 200 is determined based on a processor 120/220, a memory 110/210, a battery status, and a device health condition. The capability indicates a processing time required for the one or more partial AI models, an execution time required for the one or more partial AI models, an inference time required for the one or more partial AI models, a split time required for the one or more partial AI models, and a transfer time required for the one or more partial AI models.

The network parameter detector 142 determines the network information associated with the first electronic device 100 and the second electronic device 200. The network information includes a type of network, bandwidth information, latency information, handover information, mobility information, download link information, uplink information, a data transmission speed, a type of data transfer between the first electronic device 100 and the second electronic device 200, and size of the data transfer between the first electronic device 100 and the second electronic device 200.

The pre-processing engine 143 determines the AI model information associated with the AI model file. The AI model information includes a type of AI-architecture, a type of data used in the AI-architecture, a type of link used in the AI-architecture, and a cross-layer dependency in the AI-architecture.

The pre-processing engine 143 determines whether the adaptively streaming the AI model file from the first electronic device 100 to the second electronic device 200 is required based on the capability of the first electronic device 100 and the second electronic device 200, the network information, and the AI model information. The pre-processing engine 143 pre-process the AI model file in response to determining that the adaptively streaming the AI model file from the first electronic device 100 to the second electronic device 200 is required. The pre-processing engine 143 adaptively streams the AI model file from the first electronic device 100 to the second electronic device 200 based on the pre-processing.

The pre-processing indicates splitting a complete AI model into the one or more partial AI models at the first electronic device 100, parallel downloading of the one or more split partial AI models at the second electronic device 200 and parallel Inferencing at the second electronic device 200.

The pre-processing engine 143 analyses an AI architecture of the complete AI model of the AI model file. The pre-processing engine 143 splits the complete AI model into the one or more partial AI models based on the capability of the first electronic device 100 and the second electronic device 200, the network information, and the AI model information. The pre-processing engine 143 creates the model description file to send to the second electronic device 200. The model description file includes location information of the one or more partial AI models. The location information includes a recommended tag and/or a mandatory tag.

The pre-processing engine 143 converts a sequential model of the complete AI model into a functional model, where the functional model comprises at least one of multiple inputs, multiple outputs, shared layers, and nested models. The pre-processing engine 143 creates the model metadata for each layer of the complete AI model. The model metadata includes input layer information, output layer information, layer names, model names, inbound nodes information, and outbound nodes information. The pre-processing engine 143 stores the created model metadata in the memory 110.

The pre-processing engine 143 creates one sub-AI model for each layer based on the created model metadata sub-AI model sub-AI model storing outer configuration of the sub-AI model(s) configuration for each layer, adding input layer configuration in the sub-AI model(s) configuration based on a layer requirement for each layer, where an input layer treats as a previous layer for a current layer and the current layer treats as an output layer for the at least one sub-AI model configuration for each layer, sub-AI model, extracting weights of a current layer of the complete AI model, applying compression mechanism on the extracted weights, storing the extracted weights in the one sub-AI model into the memory 110, and creating the one sub-AI model for each layer using the extracted weights.

Although the FIG. 2A shows various hardware components of the first electronic device 100 but it is to be understood that other embodiments are not limited thereon. In other embodiments, the first electronic device 100 may include less or more number of components. Further, the labels or names of the components are used only for illustrative purpose and does not limit the scope of the disclosure. One or more components can be combined to perform same or substantially similar function to adaptively stream the AI model file.

FIG. 2B illustrates a block diagram of the second electronic device 200 for the adaptively receiving the AI model file, according to an embodiment. Examples of the second electronic device 200 include, but are not limited to a server, a cloud server, a tablet computer, a smart phone, a Personal Digital Assistance (PDA), an Internet of Things (IoT) device, etc.

In an embodiment, the second electronic device 200 includes a memory 210, a processor 220, a communicator 230, and an AI engine 240.

In an embodiment, the memory 210 stores the capability of the second electronic device 200, the model description file, model metadata, configuration information (e.g., outer configuration), and weight information.

The memory 210 stores instructions to be executed by the processor 220. The memory 210 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 210 may, in some examples, be considered a non-transitory storage medium. The term “non-transitory” may indicate that the storage medium is not embodied in a carrier wave or a propagated signal. However, the term “non-transitory” should not be interpreted that the memory 210 is non-movable. In some examples, the memory 210 can be configured to store larger amounts of information than the memory. In certain examples, a non-transitory storage medium may store data that can, over time, change (e.g., in Random Access Memory (RAM) or cache). The memory 210 can be an internal storage unit or it can be an external storage unit of the first electronic device 200, a cloud storage, or any other type of external storage.

The processor 220 communicates with the memory 210, the communicator 230, and the AI engine 240. The processor 220 is configured to execute instructions stored in the memory 210 and to perform various processes. The processor 220 may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator 230 is configured for communicating internally between internal hardware components and with external devices (e.g., eNodeB, gNodeB, server, smartphone, IoT device, etc.) via one or more networks (e.g., Radio technology). The communicator 230 includes an electronic circuit specific to a standard that enables wired or wireless communication.

The AI engine 240 is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In an embodiment, the AI engine 240 includes a tag identifier 241 and an Interfacing engine 242.

In an embodiment, the tag identifier 241 receives the one or more partial AI models from the first electronic device 100, whereas the second electronic device 200 downloads the one or more partial AI models to execute the AI model file. The tag identifier 241 determines whether the model description file includes the recommended tag or the mandatory tag. The tag identifier 241 parallel downloads the one or more partial AI models based on the recommended tag and the mandatory tag, the capability of the second electronic device 200, the network information, and the AI model information.

The Interfacing engine 242 parallel executes the one or more partial AI models by executing a first AI sub-model of the one or more partial AI models based on already available input data. The Interfacing engine 242 then detecting that inference is completed for the first AI sub-model. The Interfacing engine 242 then executing a second AI sub-model of the one or more partial AI models by using an output of the first AI model as an input for the second AI model upon detecting that inference is completed for the first AI model.

The Interfacing engine 242 loads model metadata for each layer of the complete AI model, where the model metadata includes the input layer information, the output layer information, the layer names, the model names, the inbound nodes information, and the outbound nodes information. The Interfacing engine 242 stores output of each layer along with a count, where the count indicates a number of times the output is used. The Interfacing engine 242 detects that inference is completed for the first AI model based on the count.

Although the FIG. 2B shows various hardware components of the second electronic device 200 but it is to be understood that other embodiments are not limited thereon. In other embodiments, the second electronic device 200 may include less or more number of components. Further, the labels or names of the components are used only for illustrative purpose and does not limit the scope of the disclosure. One or more components can be combined to perform same or substantially similar function to adaptively stream the AI model file.

At least one of the plurality of modules/components of the first electronic device 100 and/or the second electronic device 200 may be implemented through an AI model. A function associated with AI may be performed through memory 110/210 and the processor 120/220.

One or a plurality of processors controls the processing of the input data in accordance with a predefined operating rule or AI model stored in the non-volatile memory and the volatile memory. The predefined operating rule or artificial intelligence model is provided through training or learning.

Here, being provided through learning means that, by applying a learning process to a plurality of learning data, a predefined operating rule or AI model of a desired characteristic is made. The learning may be performed in a device itself in which AI according to an embodiment is performed, and/o may be implemented through a separate server/system.

The AI model may consist of a plurality of neural network layers. Each layer has a plurality of weight values and performs a layer operation through calculation of a previous layer and an operation of a plurality of weights. Examples of neural networks include, but are not limited to, Convolutional Neural Network (CNN), Deep Neural Network (DNN), Recurrent Neural Network (RNN), Restricted Boltzmann Machine (RBM), Deep Belief Network (DBN), Bidirectional Recurrent Deep Neural Network (BRDNN), Generative Adversarial Networks (GAN), and deep Q-networks.

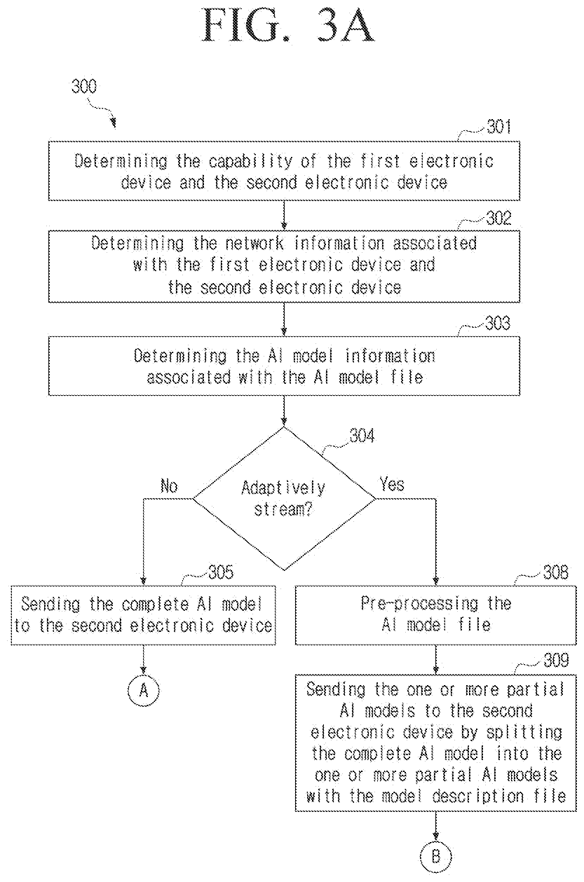

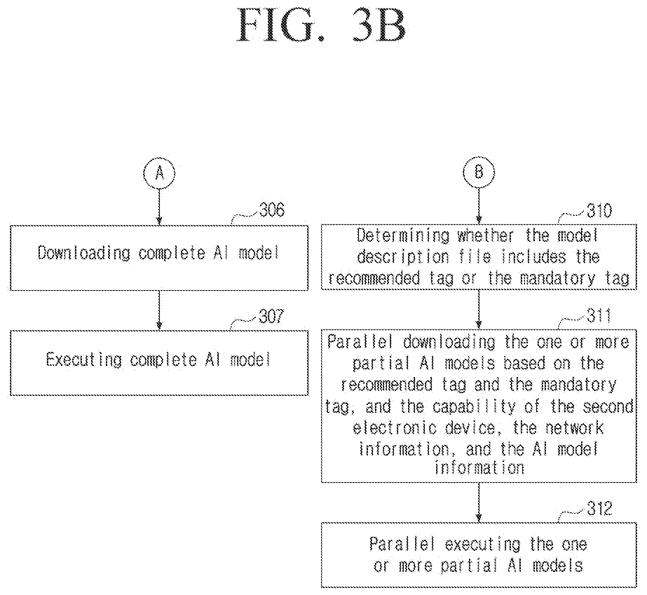

FIGS. 3A and 3B are a flow diagram 300 illustrating a method for the adaptively streaming the AI model file, according to an embodiment.

At step 301, the method includes determining the capability of the first electronic device 100 and the second electronic device 200. At step 302, the method includes determining the network information associated with the first electronic device 100 and the second electronic device 200. At step 303, the method includes determining the AI model information associated with the AI model file. At step 304, the method includes determining whether the adaptively streaming the AI model file from the first electronic device 100 to the second electronic device 200 is required based on the capability of the first electronic device 100 and the second electronic device 200, the network information, and the AI model information. The requirement of streaming the AI model file is determined based on benefits getting to the devices 100, 200 due to the streaming. For example, if the second electronic device 200 does not wait for the complete AI model to be downloaded before beginning and inferencing using the input data. Hence, there is no initial delay when the second electronic device 200 attempts to infer the complete AI model or partial AI model(s), especially when the AI model file(s) is larger in size (e.g., Terabytes) which is a benefit to the second electronic device 200.

In another example:

If the complete AI Model sending time is too small (less than pre-defined threshold value), in that case, splitting, and then sending will be overhead, which is not beneficial. As a result, the proposed method performs step 305.

If the inference time at the second electronic device 200 model is too short/less than pre-defined threshold value, which is determined based on the capability of the second electronic device 200 and the architecture of the AI model architecture analysis, this information can be deduced. The proposed method's main benefit is to parallelize the sending and execution of the model in the second electronic device 200. So, if the execution time is very short, the streaming benefit will be very small. As a result, the proposed method performs step 305.

If the splitting time of the model in the first electronic device 100 is too large/greater than pre-defined threshold value, in that case, splitting, and sending will take up a huge time, which is not beneficial. As a result, the proposed method performs step 305.

At step 305, the method includes sending the complete AI model to the second electronic device 200 in response to determining that the adaptively streaming the AI model file from the first electronic device 100 to the second electronic device 200 is not required. At steps 306-307, the method includes downloading complete AI model and executing complete AI model. At step 308, the method includes pre-processing the AI model file in response to determining that the adaptively streaming the AI model file from the first electronic device 100 to the second electronic device 200 is required. At step 309, the method includes sending the one or more partial AI models to the second electronic device 200 by splitting the complete AI model into the one or more partial AI models with the model description file. At step 310, the method includes determining whether the model description file includes the recommended tag or the mandatory tag. At step 311, the method includes parallel downloading the one or more partial AI models based on the recommended tag and the mandatory tag, and the capability of the second electronic device 200, the network information, and the AI model information. At step 312, the method includes parallel executing the one or more partial AI models.

The various actions, acts, blocks, steps, or the like in the flow diagram 300 may be performed in the order presented, in a different order or simultaneously. Further, in some embodiments, some of the actions, acts, blocks, steps, or the like may be omitted, added, modified, skipped, or the like without departing from the scope of the disclosure.

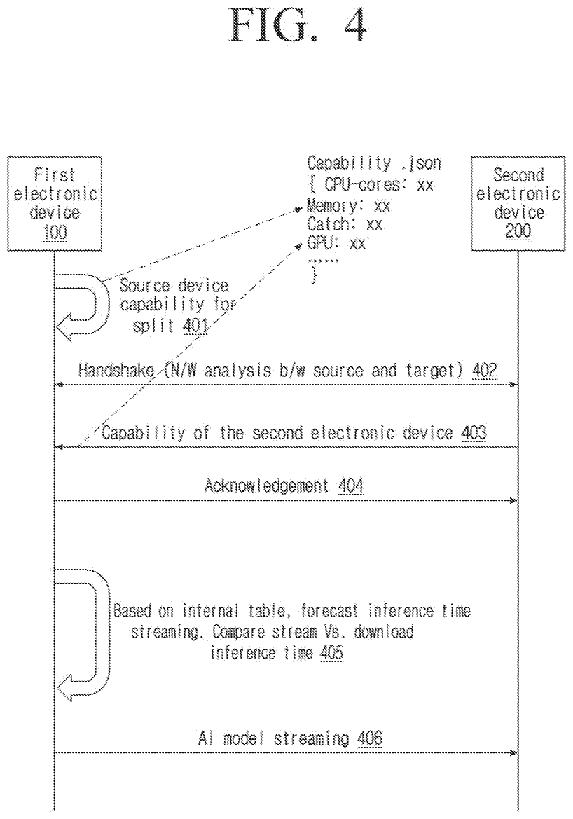

FIG. 4 is a sequence flow diagram illustrating the initial handshake between the first electronic device 100 and the second electronic device 200, according to an embodiment.

At step 401, the first electronic device 100 determines its capability for splitting the AI model file. At step 402, the first electronic device 100 performs the initial handshake with the second electronic device 200 to determine the network information associated with the first electronic device and the second electronic device 200. At step 403, the first electronic device 100 receives the capability of the second electronic device 200 from the second electronic device 200. At step 404, the first electronic device 100 sends an acknowledgment to the second electronic device 200 in response to receiving the capability of the second electronic device 200.

At steps 405-406, the first electronic device 100 determines whether the AI model file will be fully downloaded first in the second electronic device 200 and then executed, or whether the AI model file can be streamed towards the second electronic device 200 and executed (with a partial model that is independently executable) can occur in parallel. The first electronic device 100 takes a decision based on a total end-to-end execution latency between two cases (a and b) based on the initial handshake between the first electronic device 100 and the second electronic device 200,

The first electronic device 100 sends the complete AI model file to the second electronic device 200 and then executes the complete AI model file in the second electronic device 200.

The first electronic device 100 splits the complete AI model file into one or more partial AI models. The first electronic device 100 then sends one or more partial AI models to the second electronic device 200, and the second electronic device 200 performs parallel execution of one or more partial AI models in the second electronic device 200.

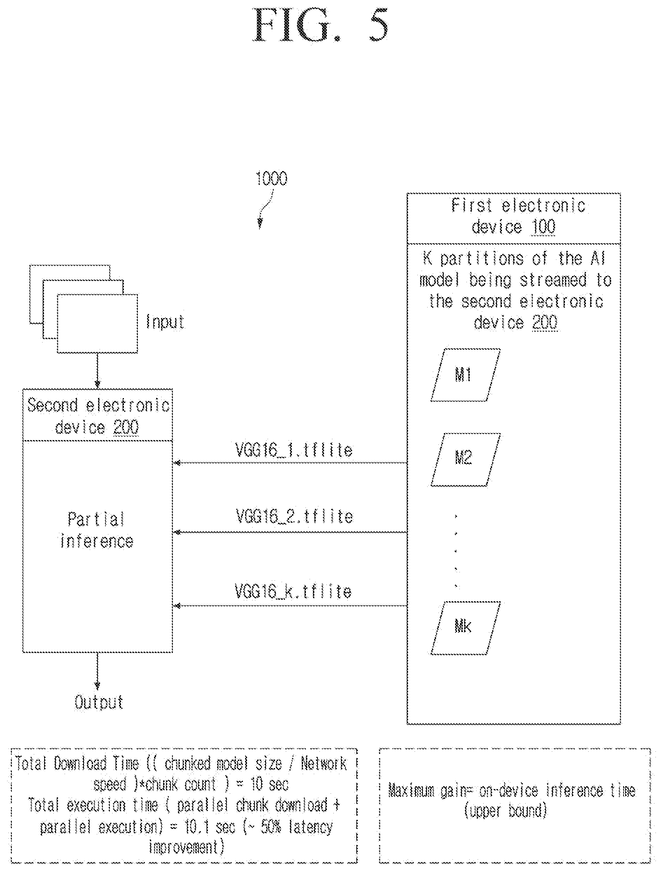

FIG. 5 illustrates a system block diagram and associated various functionality for the adaptively streaming the AI model file, according to an embodiment. The system 1000 may include, but is not limited to, the first electronic device 100 and the second electronic device 200.

The first electronic device 100 determines whether the AI model file will be fully downloaded first in the second electronic device 200 and then executed, or whether the AI model file can be streamed towards the second electronic device 200 and executed (with a partial model that is independently executable) can occur in parallel based on the capability of the first electronic device 100 and the second electronic device 200, the network information, the AI model information, and some other parameters, as shown in Table-1.

TABLE 1

| Category | Parameter | Intended functionality |
|---|---|---|
| Capability of | CPU/GPU | Processor capabilities |
| device(s) | Battery | Device battery status consideration |
| | Heat | Device heating/health consideration |
| Network | Cellular/Wi- | Network selection, bandwidth, latency |
| information | Fi/Bluetooth | |
| | Mobility | Network handover, mobility |
| | Size of data | Data transmission decision, weights of |
| | | data |
| | Type of data | Video, audio, text, binary, etc. |
| AI model | Architecture | CNN, RNN, GAN, LSTM, etc. |
| information | Data/parameter | integer, floating/fixed point, quantization |
| | Link(s) | Forward/Backward propagation |
| User focus | APP KPI | Latency requirement, service criticality |
| | Data privacy | Data transmission allowed or not |
| | Cost of hosting | Deployment cost at cloud/server |

The first electronic device 100 takes a decision based on the total end-to-end execution latency between two cases (a and b) based on the initial handshake between the first electronic device 100 and the second electronic device 200,

In the first case (download and execution), the second electronic device 200 downloads the complete AI model file and then executes the complete AI model file determined based on:

(i) determining the download time of the complete AI model, where the download time majorly depends on the network information (e.g., uplink/downlink speed) and the AI model information (e.g., size of the AI model file), and

(ii) determining the inference time of the complete AI model, where the inference time majorly depends on the capability of the second electronic device 200 (e.g., processing power) and the AI model information (e.g., model execution complexity).

Because there is no parallelization in the first case, the timings for (i) and (ii) are additive when calculating the total end-to-end model execution time.

In the second case (split, stream, and execution), the first electronic device 100 splits the complete AI model file into one or more partial AI models. The first electronic device 100 then sends one or more partial AI models to the second electronic device 200, and the second electronic device 200 performs parallel execution of one or more partial AI models in the second electronic device 200 is determined based on:

(i) determining the split time in the first electronic device 100, where the split time majorly depends on the capability of the first electronic device 100 and the AI model information,

(ii) determining a time required for downloading one or more split partial AI models at the second electronic device 200, where the time majorly depends on the network information (e.g., uplink/downlink speed) and the AI model information (e.g., size of the AI model file), and

(iii) determining a time required for inferencing the second electronic device 200, where the time majorly depends on the capability of the second electronic device 200 and the AI model information (e.g., model execution complexity).

Because there is parallelization in the second case, the timings for (i), (ii), and (iii) are not additive when calculating the total end-to-end model execution time, thereby reducing the total end-to-end model execution time.

Once the first electronic device 100 has made the decision, the AI model file is sent/received as a single file in the second electronic device 200, and once the AI model file is fully received, the input data is passed to it to obtain the final output. If the streaming and execution option is selected, the AI model file is pre-processed in the first electronic device 100, and streaming is performed for parallel execution.

Furthermore, the pre-processing in the first electronic device 100 includes:

(i) Analyzing the architecture of the AI model (layer by layer) and splitting/partitioning the AI model file into independently executable sub-models (e.g., sub-models of the AI model file). A logic to form the sub-model is dependent on the network information (e.g., network bandwidth/speed) to determine how many sub-models to form and how many layers each sub-model will contain (in other words, if the original AI model file has total N layers, then it need not be necessarily partitioned into N sub-models).

(ii) Partitioning the AI model file into pre-decided sub-models. To packetize the weights, this step may optionally include some additional optimization or compression logic. As an example, consider “Blosc Optimization.”

(iii) Creating the model description file during pre-analysis of the AI model file (step-a), with the understanding that during final inferencing/execution, not all layers of the AI model are equally important, and some can be skipped or ignored as well. In that case, the model description file will include all of the sub-model location information (for example, server IP/Uniform Resource Locator (URLs) that the second electronic device 200 can use to download the sub-models). Furthermore, all of these sub-model locations will be accompanied by the recommended tag or the mandatory tag and its corresponding size, which can be used by the second electronic device 200 to determine whether the sub-model should be skipped or used mandatorily. Optionally, each of these sub-model locations can also include the quality impact percent for the recommended sub-models (e.g., if sub-model “M1” is a recommended model type with a performance impact of 0.5% and sub-model “M2” is another recommended model type with a performance impact of 1.5%, the second electronic device 200 can choose to ignore only M1 and continue downloading M2 based on the impact).

Normally, the constituent consecutive layers of a model are not similar, and cannot skip some of these constituent layers at random because it will disrupt a data flow (given that, each layer is expected to receive vectors of unique dimension). As a result, pre-processing (step-c) is only applicable to sub-models where the data flow is unaffected by skipping some of these sub-model layers.

The second electronic device 200 then performs various actions to obtain the final output. These actions include,

The second electronic device 200 downloads the model description file.

Optionally, if the model description file contains the recommended tag with sizes and the impact percentage, decide whether to download all sub-models or some of them based on the network information (e.g., download speed).

Start downloading the sub-models one by one once the second electronic device 200 decides whether to download all sub-models or some of them based on the network information.

When sub-model-1 is downloaded to the second electronic device 200, the second electronic device 200 begins inference or execution using the previously available input data. Continue parallel downloading the sub-model-2 in the second electronic device 200.

When the sub-model-2 is downloaded in the second electronic device 200, the second electronic device 200 determines whether the sub-inferencing model-1's is complete and uses an intermediate output of the sub-model-1 as an input to the sub-model-2. If the sub-model-1 output is not available when the sub-model-2 download is finished, wait for the inference for the sub-model-1 to complete before downloading a sub-model-3. Once the sub-model-1 inference is complete, the previously received sub-model-2 can be used to infer with the intermediate output data. The same logic is applied until the last sub-model is downloaded and inferred.

Once the final output from a final sub-model is available, the data can optionally be sent to the first electronic device 100 (depending on a need), and the entire activity is completed.

The main advantage of the various actions mentioned above is that in the case of parallel execution and sub-model(s) download, the execution does not need to wait for the download to finish; instead, the execution can be done in parallel, reducing end-to-end latency.

Consider an example scenario where a network speed is 10 Mbps, total AI model file size is 100 Mb, total AI model file layer count is 100, and total AI model file execution time is 10 seconds. So, in this scenario, the total download time of the entire AI model file is 10 seconds, and the total execution time (download and execution) is 20 seconds, according to the conventional system. In the example scenario, the proposed method has a split count of 100, a chunk size of 1 Mb, and a chunk execution time of 100 msec. The proposed method has a total download time of 10 seconds ((chunked model size/network speed)*chunk count) and an execution time of 10.1 seconds (parallel chunk download+parallel execution). As a result, using the proposed method reduces end-to-end latency by approximately 50%.

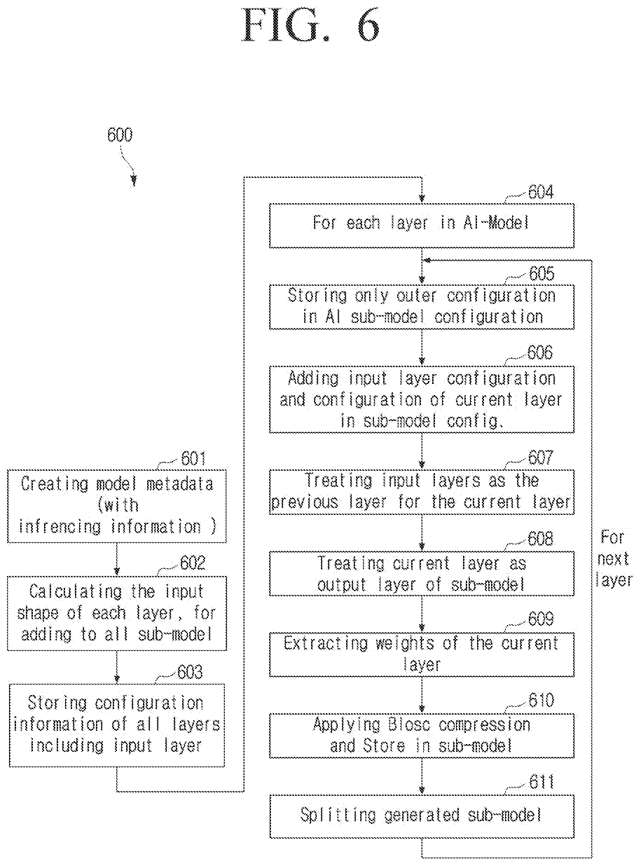

FIG. 6 is a flow diagram 600 illustrating a splitting mechanism for the adaptively streaming the AI model file, according to an embodiment.

At operation 601, if the AI model file is a sequential type, the pre-processing engine 143 converts the sequential AI model file into a functional AI model file. For example, the sequential AI model file and the functional AI model file are types of Keras model. The sequential AI model file has very limited functionality compared to the functional AI model file. In the sequential AI model file, the first layer is always as the input layer, the last layer is always the output layer, and every layer takes input from only the immediate previous layer. Hence, the sequential AI model file does not have information related to input layers, output layers, and inbound nodes (which shows from which layers this layer takes inputs). On the other hand, the functional AI model file can have multiple inputs, multiple outputs, shared layers, or nested models. So the functional AI model file adds some additional information to the sequential AI model file such as input layers, output layers, and inbound nodes, so the pre-processing engine 143 can treat the sequential AI model file as the functional AI model file. So the pre-processing engine 143 does not need to handle exceptions every time related to the input layers and the output layers. By converting the sequential AI model file into the functional AI model file, the pre-processing engine 143 generalizes the same script for both types of model e.g., sequential AI model file and functional AI model file.

When the pre-processing engine 143 splits the AI model file, there is a chance that information about the connectedness of the AI model file's layers is lost. As a result, the pre-processing engine 143 stores all necessary information in the model metadata file (e.g., JSON format). At the time of inference, the model metadata file will be required. Input layer information (‘input layers’), output layer information (‘output layers’), sequential layer names (‘layer names’), layer names (‘layer’), and model names (‘model’) are all included in the model metadata file. Because the functional AI model file treats each layer as a separate model, the functional AI model file can contain nested model(s). As a result, layer names include both the names of layers and the names of nested models sequentially. Whereas the layer only contains the names of layers, the model only contains the names of nested models. Because the nested model(s) require some changes during inference, the pre-processing engine 143 stores layer names and model names in the model metadata file, so that during inference, the pre-processing engine 143 determines whether it is the layer or the nested model.

Aside from these, the model metadata file contains two additional pieces of information for each layer: One is that each layer takes inputs from which layers (‘inbound_nodes’), and another is, how many times the output of each layer will be used as the input of another layer (‘outbound_nodes’). Each layer configuration has a parameter inbound_nodes, which contains information about this layer and takes inputs from which layers. From this, the pre-processing engine 143 stores the information about inputs of each layer in model metadata. The pre-processing engine 143 explicitly calculates outbound_nodes, for example, if layer B takes input from A, the pre-processing engine 143 increases the outbound_nodes count of layer A by one, which will be useful in sub-model inference.

At operation 602, as the pre-processing engine 143 divides the AI model file into sub-models, the pre-processing engine 143 explicitly adds an input shape to each sub-model. So the pre-processing engine 143 calculates the input shape of each layer and adds it to the sub-model at sub-model creation time. To compute output shape, for example, the pre-processing engine 143 uses built-in function compute_output_shape from Keras, this function is available for each type of Keras layer. Which is done sequentially. From the input shape of the model, it calculates the output shape of the first layer. Then for each layer, the pre-processing engine 143 calculates an output shape from the input shape of that layer. If the pre-processing engine 143 calculates the output shape of each layer, then indirectly the pre-processing engine 143 has the input shape of each layer. The input shape of the first layer is the input shape of the model. For example, if layer B takes input from layer A, the output shape of layer A is the input shape of layer B.

At operation 603, the pre-processing engine 143 stores a configuration of the input layer and a configuration of all layers, as it will be required at sub-model creation time. The input layer configuration is required to provide the input layer in each sub-mode. Configuration of all layers is required to provide the configuration of a specific layer in a specific sub-model.

At operation 604 and 605, the pre-processing engine 143 creates a sub-model configuration for each sub-model. The sub-model does not require configuration of all layers, hence first, the pre-processing engine 143 removes the configuration of all layers and keeps only some outer configuration, which is common for both model and sub-model, e.g., outer configuration.

At operation 606, as the sub-model doesn't have the original model's input and output layers configuration in the sub-model. So, the pre-processing engine 143 adds the input layer configuration as per requirements, e.g., if a layer requires two inputs, then the pre-processing engine 143 adds the input layer configuration two times. Each layer configuration has a parameter inbound_nodes, which contains information about this layer and takes inputs from which layers. It also contains information about the shared layer (A layer that is used more than one time in the model). So from inbound_nodes, the pre-processing engine 143 gets the information about a number of inputs required by the sub-model.

At operations 607 and 608, the pre-processing engine 143 adds the configuration of a current layer, model configuration has one list, which contains the configuration of all layers. Configuration of the first layer is present at 0th index. Configuration of the second layer is present at 1st index, same goes for all layers. So if the pre-processing engine 143 is creating a second model, it takes layer configuration from 1st index and adds it to the sub-model configuration. It doesn't look for whether the layer is CNN or RNN, it copies layer configuration without looking at a type of layer. In a few cases, for example, no need to look at the type of layer, in the case of the layer is the nested model(s). In some cases, there is a need to do some changes in a script, so in that case, the pre-processing engine 143 needs to determine the type of layer. For example, every Keras model needs an output layer, so it makes the current layer as the output layer. Additionally, the sub-model doesn't have previous layers of the current layer, so the pre-processing engine 143 treats the input layers as the previous layers of the current layer.

At operations 609, 610, and 611, the pre-processing engine 143 extracts weight of the current layer. The pre-processing engine 143 then applies compression mechanism on the extracted weights. The pre-processing engine 143 then stores the extracted weights in the sub-AI model(s) and creates the sub-AI model(s) for each layer using the extracted weights. Operations 605 to 611 are performed for next layer/each layer of the AI model file.

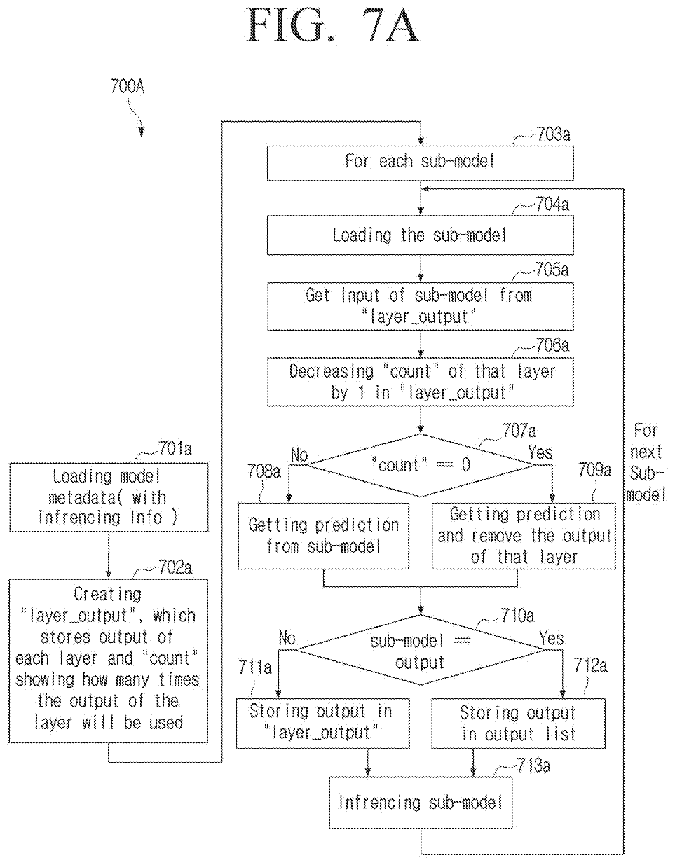

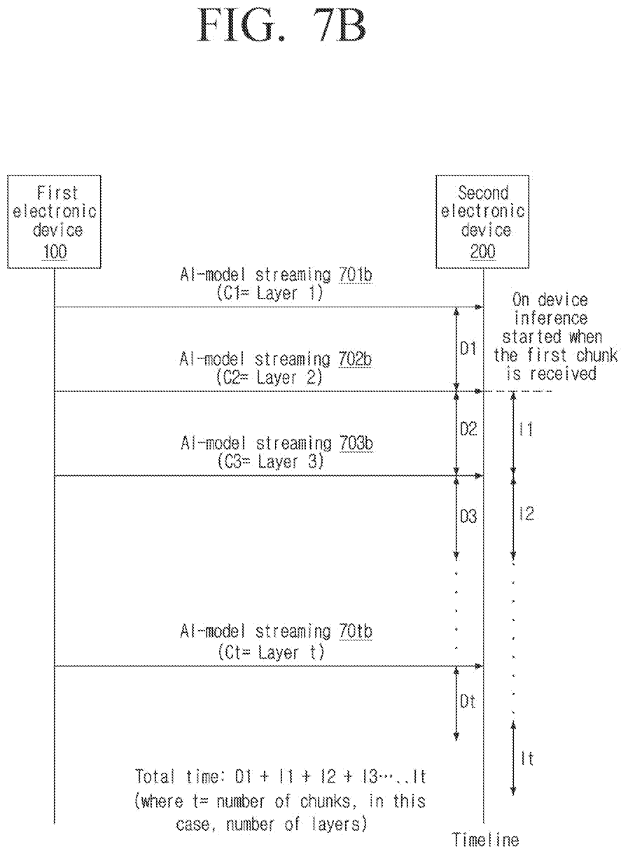

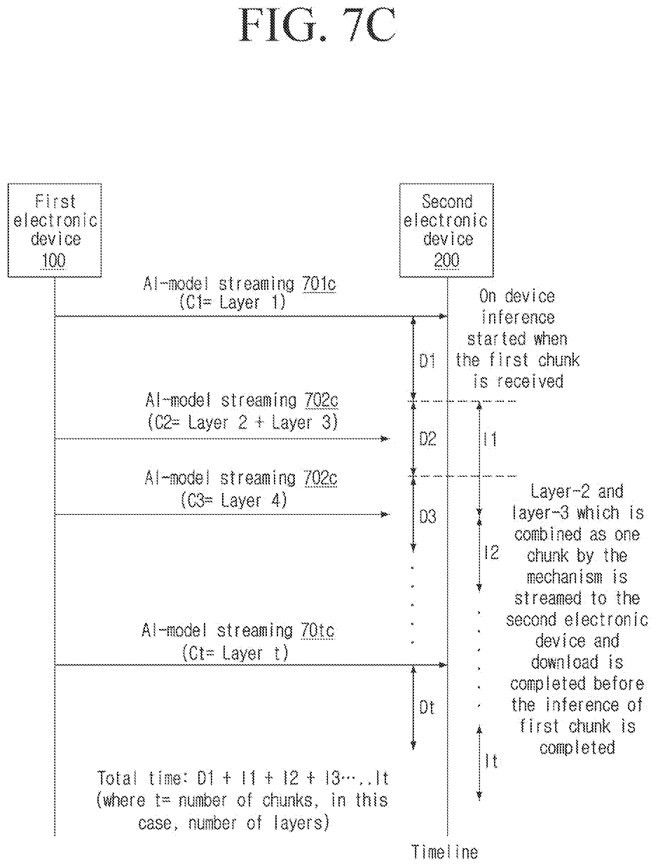

FIGS. 7A, 7B, and 7C are example sequence flow diagrams illustrating the inferencing mechanism for adaptively streaming the AI model file, according to an embodiment.

Referring to FIG. 7A (inferencing mechanism), at operation 701a, the inferencing engine 242 loads model metadata, which includes all the information that is not present in the sub-models but is required for the inferencing. At operation 702a, during streaming, the first electronic device 100 does not need to store the weights and outputs of all layers in primary memory at any given time. At operations 703a to 705a, to handle inference, the memory 210 only stores weights of that specific sub-model as the inferencing engine 242 loads sub-models one by one. If all layers are connected linearly, e.g., output from each layer is used only in the next layer, the inferencing engine 242 removes output once it is used by the next layer.

However, in today's market, more and more complex models are emerging in which each layer takes input from any previous layers. As a result, the inferencing engine 242 must store the output of each layer only if it is required in subsequent layers. So, for that sub-model inference, layer output is created, which stores the output of each layer along with a count indicating how many times that layer's output will be used. The inferencing engine 242 obtains a count from the model metadata file, which already contains that information at the time of splitting.

At operations 706a to 713a, if any layer uses the output, the inferencing engine 242 decreases the count by one (706a), and if any layer's count becomes zero (707a), the inferencing engine 242 removes (709a) that layer's output. Layer_output initially only has a count for layers. The count for each layer is obtained from the model metadata file (outbound_nodes) by the sub-model inference. Because the first layer requires input from the input layer, the inferencing engine 242 adds input array to the input layer's output list in layer_output. For example, layer_output. When any layer's count does not become zero (708a), the inferencing engine 242 then gets prediction from the sub-model.

As the inferencing engine 242 not got output from any other layer, so except the input layer, the output list of all layers is empty. Then, the inferencing engine 242 loads each sub-model one by one. In most of the cases process of getting prediction runs only one time, but in the case of a shared layer, it runs multiple times. For prediction (708a or 709a), the inferencing engine 242 takes required inputs for this layer from layer_output, as layer_output stores the output of previous layers. Further, the inferencing engine 242 takes information about inputs of the layer from the model metadata file (inbound_nodes). After that, in layer_output, sub-model inference decreases the count of the layer. If the count becomes zero (709a), the inferencing engine 242 removes the output of that layer from layer_output. The inferencing engine 242 then runs the sub-model and gets the prediction. Now, if the layer is the output layer (710a and 712a), the inferencing engine 242 stores the output in the output list otherwise (710a and 711a) the inferencing engine 242 stores the output in layer_output, as the output is needed in upcoming layers and detects that inference is completed for AI sub-model based on the count. Then, the process (704a to 713a) will repeat for all sub-models and at the end, the inferencing engine 242 gets predictions in the output list.

Referring to FIG. 7B, consider a first scenario, the complete AI-model is split into one or more partial AI-models/layers and each chunk will contain only one layer. The first scenario illustrates a next chunk download time (D {t}<=I {t−1}) is less than and equal to a previous chunk inference time.

At operation 701b, the first electronic device 100 sends AI-model streaming (C1-layer 1) as “first chunk” to the second electronic device 200. Upon receiving/downloading the AI-model streaming (C1-layer 1), the second electronic device 200 starts interfacing when the first chunk is received/downloaded completely. Here, D1 illustrates a downloading time for the first chunk and I1 illustrates an interfacing time for the first chunk. At operation 702b, the first electronic device 100 sends AI-model streaming (C2-layer 2) as “second chunk” to the second electronic device 200. Upon receiving/downloading the AI-model streaming (C2-layer 2), the second electronic device 200 starts interfacing when the second chunk is received/downloaded completely. Here, D2 illustrates a downloading time for the second chunk and 12 illustrates an interfacing time for the second chunk. At operation 703b, the first electronic device 100 sends AI-model streaming (C3-layer 3) as “third chunk” to the second electronic device 200. Upon receiving/downloading the AI-model streaming (C3-layer 3), the second electronic device 200 starts interfacing when the third chunk is received/downloaded completely. Here, D3 illustrates a downloading time for the third chunk and 13 illustrates an interfacing time for the third chunk. At operation 70tb, the same mechanism is applicable for all layers (e.g., t layer).

Referring to FIG. 7C, consider a second scenario, some layers will be combined into a single chunk and streamed to the second electronic device 200. The second scenario illustrates layer 2 and layer 3 download times that are less than the previous layer inference time. So, while layer 1 inference is being performed, the next layer/chunk (layer 2+layer 3) will be streamed and prepared for inference at the second electronic device 200.

At operation 701c, the first electronic device 100 sends AI-model streaming (C1-layer 1) as “first chunk” to the second electronic device 200. Upon receiving/downloading the AI-model streaming (C1-layer 1), the second electronic device 200 starts interfacing when the first chunk is received/downloaded completely. Here, D1 illustrates a downloading time for the first chunk and I1 illustrates an interfacing time for the first chunk. At operations 702c and 703c, the first electronic device 100 sends layer 2 and layer 3 which is combined as one chunk by the mechanism is streamed to the second electronic device 200 and download is completed before the inference (I1) of first chunk is completed. Once inference (I1) of first chunk is completed, the second electronic device 200 initiates inference (12 and 13) of combined chunk. At operation 70tc, the same mechanism is applicable for all layers (e.g., t layer).

Some existing systems make use of adaptive real-time multimedia content streaming. The term “multimedia contents” refers to image, video, or audio types of content that can be explored in terms of bit-rate/sample-rate/frame-rate and other content parameters. These variables can be changed to provide various quality variations of multimedia content. In the Korean market, for example, a video call with a mobile usually works in Video Graphics Array (VGA) resolution at 15 frames per second (fps) and 700 kbps bitrate. As a result, if the network quality improves, it can be reconfigured as HD resolution with 24 fps and 1200 kbps. If the network quality is poor, it can be set to QVGA resolution at 15 frames per second and 384 kbps. So, depending on network conditions, the multimedia content quality can be varied, essentially adapting to a network environment and providing a better video calling experience. The same is true for media streaming from any video application. Furthermore, in Dynamic Adaptive Streaming over HTTP (DASH)/HTTP Live Streaming (HLS) and other adaptive streaming cases, multimedia content is divided based on duration or media size and is playable independently on the remote end. So, in HTTP-based adaptive streaming protocols, multiple transcoded versions of the same multimedia content of various qualities exist, which are later split into small segments to send and play independently. This enables playback variation by downloading different quality levels of the same multimedia content based on a target bitrate.

However, dealing with the AI model file is not the same as dealing with multimedia content. The AI model file is typically just a configuration file containing various mathematical operations with nodes and layers and their corresponding weights. The weights and nodes are now pre-trained and cannot be changed in the conventional sense. As a result, there is no way to reduce the size of the AI model file. As a result, the concept of packetizing data based on transfer bitrate (determined by network bandwidth) does not apply to the AI model file, because the AI model file cannot be transcoded or re-encoded based on available bandwidth.

To handle the streaming for the AI model file, some additional processing is required. In the existing systems, if we consider the AI model file in “Download” mode, the first electronic device 100 (e.g., server/sender) simply packetizes the entire AI model file, splits the AI model file, and sends the AI model file based on an MTU size. However, when these packets are received by the second electronic device 200, they are just some random packets that cannot be de-packetized and executed independently. It is necessary to wait for all of the packets to be received before de-packetizing the entire thing and extracting the entire AI model file from it. After extracting the AI model file, the complete AI model file is inferred using the input data and received output.

However, in the case of streaming/the proposed method, the packets are sent in such a way that, if not every packet, then at least two or three packets are independently de-packetized and inferred. As a result, the receiving and inference portions of these packets become parallel. So, if the proposed method can be optimized based on network bandwidth and inference times, it is possible that by the time nth sub-model is downloaded, the second electronic device 200 already has the output from “n−1th” sub-model and the “n” sub-model can be inferred immediately. As a result, when the last sub-model (nth sub-model) is received, the second electronic device 200 only waits to infer the last sub-model, rather than the entire model. As a result, in all cases where total inference time needs to be optimized, the proposed method can improve end-to-end inference time by parallelizing AI model file download and execution.

Some existing systems use split computing, in which a source device (e.g., server, mobile) has computational complexities due to processing constraints, and some of the AI model file is processed in one or more other devices. The destination device (e.g., server, mobile) can now be another high-end device, a high-end edge-server, the cloud, or any other electronic device with processing power. The split is accomplished by taking the processing capabilities of the source device, the capabilities of the destination device, and the network strength/bandwidth into account, and determining which parts of the AI model file need to be executed where. Essentially, the split computing method improves total inference time by some parallel computation or sequential faster computation. However, split computing never considers how the portion of the AI model file (which is decided to be executed in the destination device) will be sent. It simply assumes that once the splitting decision is made, that percentage of the AI model file or layers will be sent from the source device to the destination device.

While the method according to an embodiment provides information about a transmission section of the AI model file, the first electronic device 100 capability in this context does not simply refer to the Inference capability. The method also includes the AI model file splitting capability and processing speed. Similarly, some of the other parameters under consideration, such as battery/heat, application latency requirement, and so on, are unique to this type of streaming proposal, as additional device resources will be used for splitting the AI model file as well as parallelizing processes (splitting and sending sub-model). Furthermore, the proposed method optimizes steps to compress or optimize the weight marketization method in such a way that a total AI model file size to be streamed can be reduced without sacrificing prediction accuracy.

Furthermore, splitting the AI model file is not affected by the type of AI model or the number of sub-layers/operations/nodes. The method is applicable for various model architectures involving CNN, RNN, and hybrid architectures, and is able to apply a similar mechanism to create sub-models for all of these cases. The proposed method is extendable with other model architectures such as Generative adversarial network (GAN), with minor changes.

Furthermore, the method applies to all scenarios in which the AI model file must be delivered from the first electronic device 100 (e.g., server) to the second electronic device 200 (e.g., client device/receiving device/smartphone). The proposed method applies wherever the first electronic device 100 (for example, where the original model is available) lacks sufficient processing speed to quickly infer the AI model file due to processing/computing capability limitations. All use-cases that require some AI model file execution in low-processing devices, such as home Internet of Things (IoT) equipment (e.g., Television (TV), refrigerator, Air conditioning (AC), and home-hub), low-end mobile phones, and so on, will use the proposed method to share the AI model file execution in other nearby devices. Furthermore, given that these devices are mostly rendering devices with very low computation capability and the operations performed in them require Three-Dimensional (3D) graphics, volumetric processing, and image/video analysis capabilities, these types of model offloading/processing offloading scenarios are quite common in the age of Augmented Reality (AR) glass and Metaverse.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of example embodiments, those skilled in the art will recognize that the embodiments herein can be practiced with modification within the scope of the embodiments as described herein.

What is claimed is:

1. A method for adaptively streaming an artificial intelligence (AI) model file from a first electronic device to a second electronic device, the method comprising:
determining, by the first electronic device, a capability of the first electronic device and a capability of the second electronic device;
determining, by the first electronic device, network information associated with the first electronic device and the second electronic device;
determining, by the first electronic device, AI model information associated with the AI model file;
based on the capability of the first electronic device, the capability of the second electronic device, the network information, and the AI model information, determining, by the first electronic device, whether to adaptively stream the AI model file from the first electronic device to the second electronic device;
pre-processing the AI model file, by the first electronic device, based on the determining to adaptively stream the AI model file from the first electronic device to the second electronic device; and
adaptively streaming the AI model file, by the first electronic device, from the first electronic device to the second electronic device based on the pre-processing.

2. The method of claim 1, wherein the capability of the first electronic device and the capability of the second electronic device are determined based on at least one of a processor, a memory, a battery status, and a device health condition of the first electronic device or the second electronic device.

3. The method of claim 1, wherein the capability of the first electronic device or of the second electronic device indicates at least one of a processing time for at least one partial AI model, an execution time for the at least one partial AI model, an inference time for the at least one partial AI model, a split time for the at least one partial AI model, and a transfer time for the at least one partial AI model.

4. The method of claim 1, wherein the network information comprises a type of network, a bandwidth information, a latency information, a handover information, a mobility information, a download link information, an uplink information, a data transmission speed, a type of data transfer between the first electronic device and the second electronic device, and a size of the data transfer between the first electronic device and the second electronic device.

5. The method of claim 1, wherein the AI model information comprises a type of AI-architecture, a type of data used in the type of AI-architecture, a type of link used in the AI-architecture, and a cross-layer dependency in the AI-architecture.

6. The method of claim 1, wherein the pre-processing indicates at least one of a split of a complete AI model into at least one partial AI model at the first electronic device, a parallel download of the at least one partial AI model at the second electronic device, a parallel inference at the second electronic device, and encoding the at least one partial AI model.

7. The method of claim 6, wherein the pre-processing comprises:
analyzing, by the first electronic device, an AI architecture of the complete AI model of the AI model file;
splitting, by the first electronic device, the complete AI model into the at least one partial AI model based on the capability of the first electronic device, the capability of the second electronic device, the network information, and the AI model information; and
creating, by the first electronic device, a model description file to send to the second electronic device, wherein the model description file comprises a location information of the at least one partial AI model, and wherein the location information comprises at least one of a recommended tag and a mandatory tag.

8. The method of claim 7, wherein the splitting, by the first electronic device, the complete AI model into the at least one partial AI model comprises:
converting, by the first electronic device, a sequential model of the complete AI model into a functional model, wherein the functional model comprises at least one of multiple inputs, multiple outputs, shared layers, and nested models;
creating, by the first electronic device, model metadata for each layer of the complete AI model, wherein the model metadata comprises at least one of input layer information, output layer information, layer names, model names, inbound nodes information, and outbound nodes information;
determining, by the first electronic device, an input shape for each layer;
storing, by the first electronic device, the model metadata and the input shape for each layer into a memory; and
creating, by the first electronic device, at least one sub-AI model for each layer based on the model metadata.

9. The method of claim 8, wherein the creating, by the first electronic device, the at least one sub-AI model for each layer based on the model metadata comprises:
storing, by the first electronic device, outer configuration of the at least one sub-AI model configuration for each layer;
adding, by the first electronic device, input layer configuration in the at least one sub-AI model configuration based on a layer requirement for each layer, wherein an input layer is treated as a previous layer for a current layer and the current layer is treated as an output layer for the at least one partial-AI model configuration for each layer;
extracting, by the first electronic device, weights of a current layer of the complete AI model;
applying, by the first electronic device, a compression mechanism on the extracted weights;
storing, by the first electronic device, the extracted weights in the at least one sub-AI model; and
creating, by the first electronic device, the one sub-AI model for each layer using the extracted weights.

10. The method of claim 1, further comprising:
receiving, by the second electronic device, the AI model file from the first electronic device to the second electronic device,
wherein the AI model file includes at least one partial AI model from the first electronic device, and
wherein the second electronic device downloads the at least one partial AI model to execute the AI model file.

11. The method of claim 10, wherein the receiving, by the second electronic device, the at least one partial AI model from the first electronic device further comprises:
determining, by the second electronic device, whether a model description file comprises a recommended tag or a mandatory tag;
parallel downloading, by the second electronic device, the at least one partial AI model based on the recommended tag and the mandatory tag, and the capability of the second electronic device, the network information, and the AI model information; and
parallel executing, by the second electronic device, the at least one partial AI model.

12. The method of claim 11, wherein the parallel executing, by the second electronic device, the at least one partial AI model comprises:
executing, by the second electronic device, a first AI sub-model of the at least one partial AI model based on already available input data;
detecting, by the second electronic device, that an inference is completed for the first AI sub-model; and
executing, by the second electronic device, a second AI sub-model of the at least one partial AI model by using an output of the first AI model as an input for the second AI model upon detecting that the inference is completed for the first AI model.

13. The method of claim 12, wherein the detecting, by the second electronic device, that the inference is completed for the first AI model comprises:
loading, by the second electronic device, model metadata for each layer of the complete AI model, wherein the model metadata comprises at least one of input layer information, output layer information, layer names, model names, inbound nodes information, and outbound nodes information;
storing, by the second electronic device, an output of each layer along with a count, wherein the count indicates a number of times the output is used; and
detecting, by the second electronic device, that the inference is completed for the first AI model based on the count.

14. The method of claim 1, wherein the capability of the first electronic device and the capability of the second electronic device are determined based on an initial handshake between the first electronic device and the second electronic device.

15. A first electronic device for adaptively streaming an artificial intelligence (AI) model file, the first electronic device comprising:
a memory storing instructions; and
at least one processor configured to execute the instructions to:
determine a capability of the first electronic device and a capability of a second electronic device;
determine network information associated with the first electronic device and the second electronic device;
determine AI model information associated with the AI model file;
based on the capability of the first electronic device, the capability of the second electronic device, the network information, and the AI model information, determine whether to adaptively stream the AI model file from the first electronic device to the second electronic device;
pre-process the AI model file based on the determining to adaptively stream the AI model file from the first electronic device to the second electronic device; and
adaptively stream the AI model file from the first electronic device to the second electronic device based on the pre-processing.

16. The first electronic device of claim 15, wherein the pre-processing indicates at least one of a split of a complete AI model into at least one partial AI model at the first electronic device, a parallel download of the at least one partial AI model at the second electronic device, a parallel inference at the second electronic device, and encoding the at least one partial AI model.

17. The first electronic device of claim 16, wherein the at least one processor is further configured to execute the instructions to:
analyze an AI architecture of the complete AI model of the AI model file;
split the complete AI model into the at least one partial AI model based on the capability of the first electronic device, the capability of the second electronic device, the network information, and the AI model information; and
create a model description file to send to the second electronic device, wherein the model description file comprises a location information of the at least one partial AI model, wherein the location information comprises at least one of a recommended tag and a mandatory tag.

18. The first electronic device of claim 17, wherein the at least one processor is further configured to execute the instructions to:
convert a sequential model of the complete AI model into a functional model, wherein the functional model comprises at least one of multiple inputs, multiple outputs, shared layers, and nested models;
create model metadata for each layer of the complete AI model, wherein the model metadata comprises at least one of input layer information, output layer information, layer names, model names, inbound nodes information, and outbound nodes information;
determine an input shape for each layer;
store the model metadata and the input shape for each layer into the memory; and
create at least one sub-AI model for each layer based on the model metadata.

19. The first electronic device of claim 18, wherein the at least one processor is further configured to execute the instructions to:
store outer configuration of the at least one sub-AI model configuration for each layer;
add input layer configuration in the at least one sub-AI model configuration based on a layer requirement for each layer, wherein an input layer treats as a previous layer for a current layer and the current layer treats as an output layer for the at least one partial-AI model configuration for each layer;
extract weights of a current layer of the complete AI model;
apply a compression mechanism on the extracted weights;
store the extracted weights in the at least one sub-AI model; and
create the one sub-AI model for each layer using the extracted weights.

20. The first electronic device of claim 15, wherein the at least one processor is further configured to execute the instructions to:
receive the AI model file from the first electronic device to the second electronic device,
wherein the AI model file includes at least one partial AI model from the first electronic device, and
wherein the second electronic device downloads the at least one partial AI model to execute the AI model file.
